(19) United States
(12) Patent Application Publication
(10) Pub. No.: US 2017/0259180 A1
(43) Pub. Date: Sep. 14, 2017

(54) SPORTS STRATEGY SYSTEM AND METHOD

(71) Applicant: Noah Kevin Slater, Costa Mesa, CA (US)

(72) Inventor: Noah Kevin Slater, Costa Mesa, CA (US)

(21) Appl. No.: 15/458,855

(22) Filed: Mar. 14, 2017

Related U.S. Application Data
(60) Provisional application No. 62/308,070, filed on Mar. 14, 2016.

(51) Int. Cl. A63F 13/828; A63F 13/67; A63F 13/46; A63F 13/65

(52) U.S. Cl. CPC A63F 13/828; A63F 13/65; A63F 13/67; A63F 13/46; A63F 2300/8052

(57) ABSTRACT

An apparatus and a method are provided for a sports strategy system, comprising a processor. Storage media is communicatively coupled to the processor, and the storage media includes logic configured to display a graphical user interface comprising a strategy vista interface. The graphical user interface features one or more sport-specific elements and a score region. Player attribute logic is included to store a plurality of player profiles that correspond to a plurality of players in a sports game. Matrix logic is configured to store all potential game outcomes, and filter application logic is configured to store offensive and defensive filters so as to provide one or more game scenarios.

### CROSS-REFERENCE TO RELATED APPLICATION

This application claims the benefit of priority of U.S. Provisional Application No. 62/308,070, filed Mar. 14, 2016.

### FIELD

The field of the present disclosure generally relates to strategy games. More particularly, the field of the invention relates to a system and a method for a sports strategy game based on a plurality of statistical elements.

### BACKGROUND

A fantasy sport (also known less commonly as rotisserie or roto) is a type of online game where participants assemble imaginary or virtual teams of real players of a professional sport. These teams compete based on the statistical performance of those players in actual games. This performance is converted into points that are compiled and totaled according to a roster selected by each fantasy team's manager. These point systems can be simple enough to be manually calculated by a “league commissioner” who coordinates and manages the overall league, or points can be compiled and calculated using computers tracking actual results of the professional sport. Conventionally, in fantasy sports, team owners draft, trade and cut (drop) players, analogously to real sports.

A large factor in the growth of fantasy sports was the rise of the Internet and personal computers in the mid-1990s. The new technology lowered the barrier to entry to the hobby as stats could quickly be compiled online and news and information became readily available.

Daily fantasy sports, an accelerated variant of the concept, began to experience a major increase in prominence in 2014 and 2015. Daily fantasy games are played across shorter periods of time, such as a single week of a season, rather than an entire season. Daily fantasy games are typically played as “contests” subject to an entry fee, which funds an advertised prize pool and is partially raked-off as revenue for the service.

Unfortunately, conventional sports games such as fantasy sports, for example, fail to include a strategy element beyond basic analysis of relevant teams and players. Moreover, even if further analysis is included, it could overwhelm the players, causing an undesirable reduction in usage of the game. What is needed, therefore, is a sports strategy gaming system and method based on a plurality of statistical elements featuring an elegant and easy to use graphical user interface.

### BRIEF DESCRIPTION OF THE DRAWINGS

The drawings refer to embodiments of the present disclosure in which:

FIG. 1 is an exemplary graphical user interface of the gaming system;

FIG. 2 is a flowchart of an exemplary method for utilizing the gaming system;

FIG. 3 is an exemplary player attribute logic table featuring a plurality of attributes specific to a plurality of players;

FIG. 4A is an exemplary outcome matrix featuring a plurality of filters;

FIG. 4B is an exemplary result matrix featuring results from the filters of FIG. 4A;

FIG. 5A-5C show various views of the strategy vista of the graphical user interface of FIG. 1; and

FIG. 6 is an exemplary mobile device with the gaming system of FIG. 1 loaded thereon.

While the present disclosure is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the invention disclosed herein may be practiced without these specific details. Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein. Moreover, in the following description, certain terminology is used to describe features of the invention.

The term “computerized” generally represents that any corresponding operations are conducted by hardware in combination with software and/or firmware. Also, the terms “compare” or “comparison” generally mean determining if a match (e.g., a certain level of correlation) is achieved between two items where one of the items may include a particular signature pattern.

In certain situations, the term “logic,” is representative of hardware, firmware and/or software that is configured to perform one or more functions. As hardware, logic (or engine or component) may include circuitry having data processing or storage functionality. Examples of such circuitry may include, but are not limited or restricted to a microprocessor, one or more processor cores, a programmable gate array, a microcontroller, an application specific integrated circuit, wireless receiver, transmitter and/or transceiver circuitry, semiconductor memory, or combinatorial logic.

Logic may be software in the form of one or more software modules, such as executable code in the form of an executable application, an application programming interface (API), a subroutine, a function, a procedure, an applet, a servlet, a routine, source code, object code, a shared library/dynamic load library, or one or more instructions. These software modules may be stored in any type of a suitable non-transitory storage medium, or transitory storage medium (e.g., electrical, optical, acoustical or other form of propagated signals such as carrier waves, infrared signals, or digital signals). Examples of non-transitory storage medium may include, but are not limited or restricted to a programmable circuit; a semiconductor memory; non-persistent storage such as volatile memory (e.g., any type of random access memory “RAM”); persistent storage such as non-volatile memory (e.g., read-only memory “ROM”, power-backed RAM, flash memory, phase-change memory, etc.), a solid-state drive, hard disk drive, an optical disc drive, or a portable memory device. As firmware, the executable code is stored in persistent storage.

Finally, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

In general, the present disclosure describes a sports strategy system and method based on a plurality of statistical elements featuring an elegant and easy to use graphical user interface. In one embodiment, the sports strategy system features a graphical user interface comprising a plurality of filters that may have either an active or inactive state. The various states and filters may feature a plurality of colors, patterns and/or designs so as to represent various designations. It is envisioned that the system provides unique simulations to users by creating opportunities for the user to force specific outcomes contingent upon one or more attributes that may be assigned to one or more players. In the interests of convenience and brevity, embodiments of the gaming system are described in the context of a baseball game. It should be understood, however, that the gaming system may be implemented for nearly any sport, including by way of non-limiting example, cricket, basketball, football, soccer, polo, racing and the like,

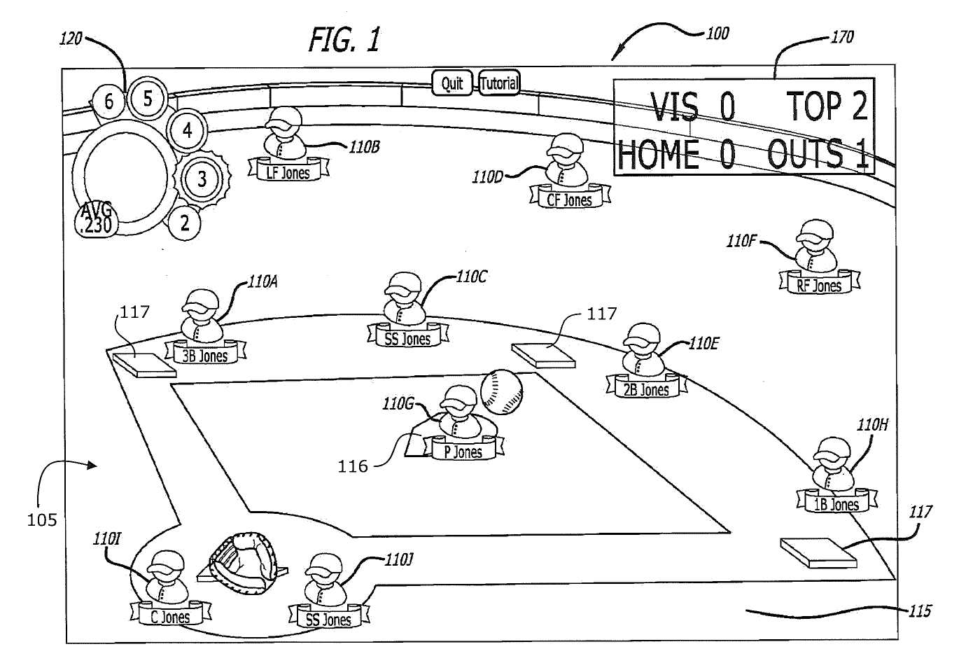

FIG. 1 illustrates an exemplary graphical user interface (hereinafter “GUI”) 105 of the gaming system 100. The GUI 105 is configured so as to allow users to interact with electronic devices through graphical icons and visual indicators such as secondary notation, as opposed to text-based interfaces, typed command labels or text navigation. In one embodiment, the GUI 105 is responsive to a mouse/cursor, for example, and/or capacitive touch. As shown, the GUI 105 comprises a plurality of representative players 110a-110j, wherein each player may represent an offensive or defensive player, depending on the team and inning, for example. As discussed further herein, each of the players 110a-110j may have respective attributes assigned to them. The GUI 105 also comprises a background 115, which in one embodiment includes one or more sport-specific elements, such as a field, and other relevant elements of the sport being simulated. Consequently, as shown in FIG. 1, a baseball diamond 116 and bases 117 are also included in the background 115. Preferably, the GUI 105 comprises a strategy vista 120, which is configured so as to visually indicate attributes of players, including for example, batting averages and numbers that may relate to offensive or defensive filters as discussed further herein. In one embodiment, the strategy vista 120 appears when a player is selected or otherwise in an actionable state, such as when a player is “up-to-bat” or pitching.

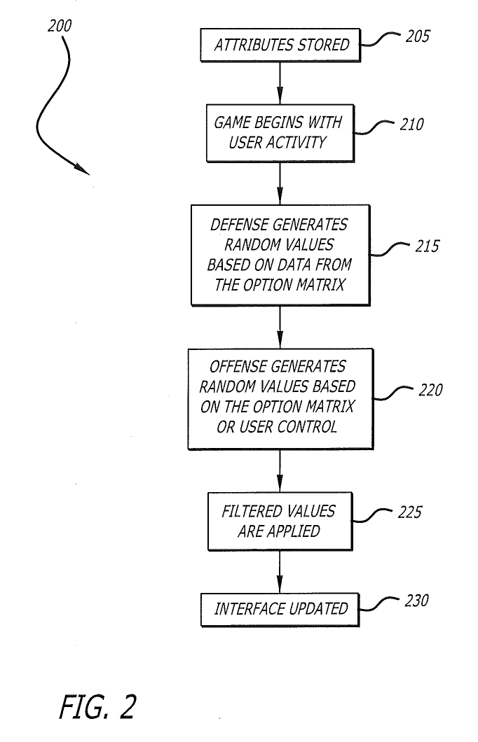

FIG. 2 illustrates an exemplary method of the gaming system 100. At block 205, various player profiles and corresponding attributes are stored in a player attribute logic table 300, which is described further herein. It is envisioned that the elements of the player attribute logic table 300 may be updated from time to time, on a periodic or a periodic basis. In one embodiment, the attributes of the logic table 300 may be updated remotely, based on new statistics of a new and/or previous season, for example. In one embodiment, at block 210, the game begins with user activity. The user activity may vary depending on the game, however, it is contemplated that a start screen and options to select a team, sport, etc. will be provided. Actual game play in the context of baseball, of course, begins by the user pitching the ball (if playing defense) or batting the ball (if playing offense). It should be understood that each player at-bat (“batter”) ultimately results in an outcome. In one embodiment, as shown at block 215, the defense first generates a pair of values ranging from 1 to 6, which are representative of defensive scenarios (e.g. “[3, 4]”) that correspond to a row in the outcome matrix 400, for example. In one embodiment, the defense may generate a random value. Depending on the quality of the pitcher's attributes, a strikeout of the batter may result.

At block 220, assuming that the batter is not struck out, the offensive player (e.g., the batter) generates an offensive value corresponding to the columns 415 from the outcome matrix 400. In one embodiment, the offensive values range from 1-6, however, it is envisioned that the player can exert further control over the outcomes of the game if they have earned, for example, a certain number of points, purchased in-game credits, or unlocked a certain number of achievements. In one embodiment, it is envisioned that certain players (whether playing offense or defense) may have clutch points assigned to them. In one embodiment, the clutch points are a recognition in the game that the player is a well-regarded player, or that they have some personality traits that make them stronger in certain scenarios. For example, clutch points may be awarded to players that are particularly good in a certain inning, or at a particular number of strikes, for example. Consequently, clutch points may be utilized so as to manually select a certain defense value ranging from 1-6.

At block 225, once the offensive and defensive values have been established, a particular outcome 418_{1, . . . N} may result. In other words, the offense and defense values may be considered to be filters, that when applied to all possible outcomes 418_{1, . . . N} correspond to what actually occurs at that time or instance of the game. It should be understood that the exact number of filters, values and outcomes may vary according to the game that is being simulated. In one embodiment, the offensive and defensive values represent all possible outcomes in a particular game. In one embodiment, each batter may feature a special or unusual outcome when at-bat, based on the quality of the batter's statistics, which, as indicated herein, may vary greatly depending on how the system 100 is programmed. For example, if the batter has a very high batting average, then special outcomes may be available. At block 230, once the player is at bat, the strategy vista interface 120 is altered so as to reflect any of the various values and/or attributes as discussed herein. The rate and speed of the gameplay may be modulated depending on how much user interaction is desired. For example, in one embodiment, user interaction may be maximized, such that the user may be provided the option to click or otherwise interact with the GUI 105 at every stage of progression with respect to the game. In one embodiment, user interaction may be minimized such that the user need only select a team, and the various scenarios auto-populate accordingly.

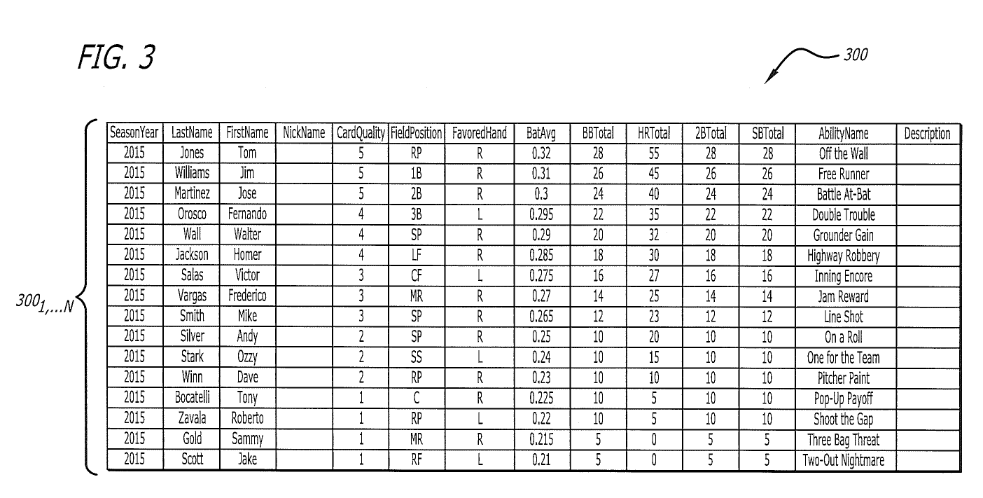

FIG. 3 illustrates an exemplary player attribute logic table 300. In one embodiment, the player attribute logic table 300 comprises data that is preferably applied to a plurality of players that are accessible using the gaming system 100. The player attribute logic table 300 features a plurality of player profiles 300_{1, . . . N}, N>1. It should be understood that each player, for example, will have varying capabilities, so as to cause strategic decisions to be made, which is central to the purpose of the game. Indeed, the variances in teams, especially when considered more granularly on a per-player basis, will cause gaps in offense or defense, for example. Whereas a player may have strength when batting, the same player may have weaknesses especially when opposing certain other defensive players, for example. As shown, the player attribute logic table 300 comprises information regarding the season year, the first and last name of the player, an optional nickname, a quality score, a field position, the player's favorite hand (e.g., left or right), the player's batting average, home-run total, second base total, and the like, without limitation. In one embodiment, an “ability name” field may be included in the player attribute logic table 300, reflecting an idiosyncratic ability of the player. For example, in one embodiment, the player may be able to go “Off the Wall” to catch a ball, etc. Although the player attribute logic table 300 is shown as a grid comprising a plurality of rows and columns, it should be understood that any other mechanism or model of storing information may be used. In one embodiment, a relational or star schema model may be used. In one embodiment, the star schema model consists of fact tables and dimension tables. Relationship tables may also be utilized, including one-to-one, one-to-many, and many-to-many. It is envisioned that in more complex and varied data types, the systems described herein may utilize queries written in object query language (OQL), by way of non-limiting example. Any number of attributes may be programmed and stored with respect to each player. It should be understood that the more attributes that are included, the more strategy that will be required to play and effectively be successful at the game.

In one embodiment, the attributes of the logic table 300 comprise a plurality of other statistics, including by way of non-limiting example, 1B—Single: hits on which the batter reaches first base safely without the contribution of a fielding error; 2B—Double: hits on which the batter reaches second base safely without the contribution of a fielding error; 3B—Triple: hits on which the batter reaches third base safely without the contribution of a fielding error; AB—At bat: Plate appearances, not including bases on balls, being hit by pitch, sacrifices, interference, or obstruction; AB/HR—At bats per home run: at bats divided by home runs; BB—Base on balls: hitter not swinging at four pitches called out of the strike zone and awarded first base; BABIP—Batting average on balls in play: frequency at which a batter reaches a base after putting the ball in the field of play; BB/K—Walk-to-strikeout ratio: number of bases on balls divided by number of strikeouts; EQA—Equivalent average: a player's batting average absent park and league factors; FC—Fielder's choice: times reaching base safely because a fielder chose to try for an out on another runner; and GO/AO—Ground ball fly ball ratio: number of ground ball outs divided by number of fly ball outs. It should be understood that the statistics may include any number of features specific to both offensive and defensive players, without limitation.

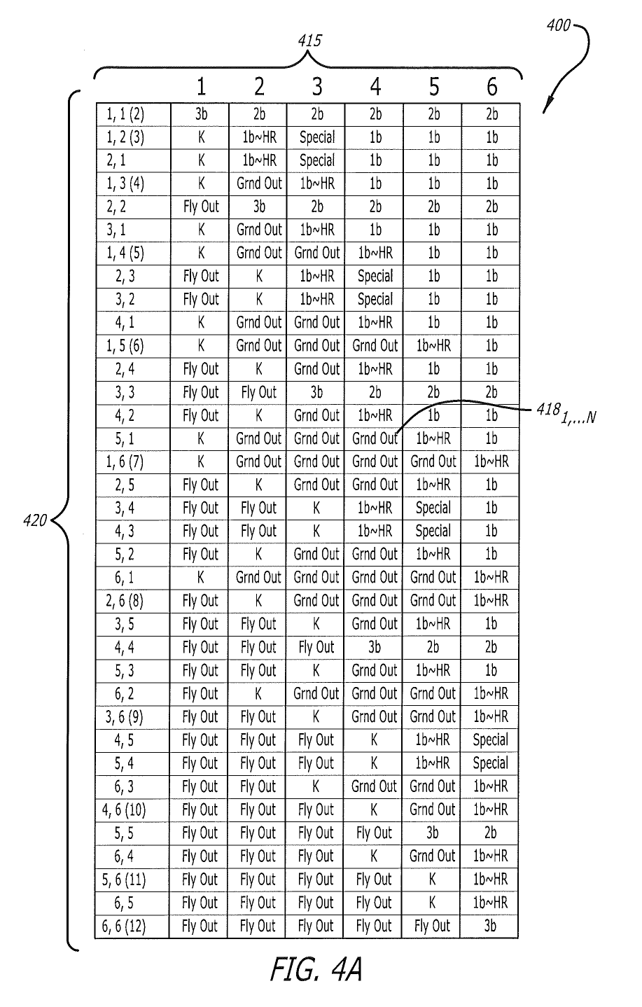

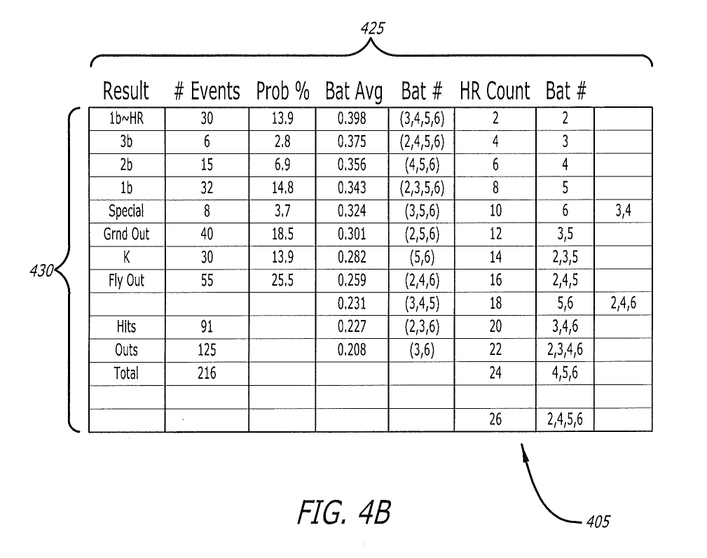

FIG. 4A illustrates the outcome matrix 400 in accordance with embodiments of the disclosure. In one embodiment, the outcome matrix 400 features a defensive filter 420 comprising a plurality of rows that are representative of various defensive outcomes as discussed herein. Although only a finite number of rows are shown, it should be understood that any number of row may be programmed and/or otherwise utilized with respect to the gaming system 100. In one embodiment, the outcome matrix 400 features an offensive filter 415 comprising a plurality of columns. In totality, it should be understood that the outcome matrix 400 is representative of all possible combinations of offensive and defensive outcomes. It is only when a particular offensive filter 415 and defensive filter 420 is selected that the actual game outcome at a particular instance or time is determined. In one embodiment, the offensive filter 415 comprises a single number value, whereas the defensive filter 420 comprises a pair of numerical values. It should be understood that the configuration of the various filters as discussed herein may vary in size, style and type without exceeding beyond the spirit and scope of the present disclosure.

In one embodiment, the offensive and/or defensive filters may be visualized on-screen using a pair of dice. As such, once there is a user interaction with the GUI 105, the defense may be simulated using any of the following combinations: (1,1); (1,2); (1,3); (1,4); (1,5); (1,6); (2,1); (2,2); (2,3); (2,4); (2,5); (2,6); (3,1); (3,2); (3,3); (3,4); (3,5); (3,6); (4,1); (4,2); (4,3); (4,4); (4,5); (4,6); (5,1); (5,2); (5,3); (5,4); (5,5); (5,6); (6,1); (6,2); (6,3); (6,4); (6,5); and (6,6). Of course, this is the exemplary set of results for a two-dice combination. The dice “roll” may then correspond to the defensive filter 420, thereby controlling the event outcome based on the offense. Similarly, the offence may be simulated using a single dice roll, where the combinations are the single values 1; 2; 3; 4; 5; and 6. With respect to the defensive filter 420, it is important to note that there are 36 possibilities for (a,b). This total number of possibilities can be obtained from the multiplication principle: there are 6 possibilities for “a”, and for each outcome with respect to “a”, there are 6 possibilities for “b”. So, the total number of joint outcomes (a,b) is 6×6, which is 36. The set of all possible outcomes for (a,b) may be noted as the sample space of the defense.

Similarly, depending on the game, there may be more dice used, thereby increasing the number of possible combinations that control game play. With the sample space now identified, formal probability theory generally requires that all possible events be identified. These are subsets of the sample space, and generally form a sigma-algebra. In an example such as this, where the sample space is finite as it has only 36 different outcomes, it is perhaps easiest to simply declare all subsets of the sample space to be possible events, and then filter them according to the offensive possibilities.

FIG. 4B illustrates a result matrix 405 that represents the filtered outcomes from the outcome matrix 400 of FIG. 4A. As shown, the columns 425 may indicate the particular result in the game, the number of times the result occurs, probability of that event occurring, the batting average, the bat number/sequence, the home run count, etc., without limitation. More specifically, for example, when the defensive filter 420 is coupled with the offensive filter 415, every possible combination of game outcomes is accounted for. For example, as shown in the rows 430, in one embodiment, the probability of a “fly out” may be substantially “25.5%” as compared to all other programmed outcomes; the outcome of a “ground out” may be substantially “18.5%” as compared to all other programmed outcomes; and the probability of a “1B” may be substantially “14.8%” as compared to all other programmed outcomes. It should be understood that the various events may be desirably modified so as to effect their frequency and/or probabilities of occurrence in the game. It is envisioned that such outcomes may be periodically or a periodically updated on an as-need basis.

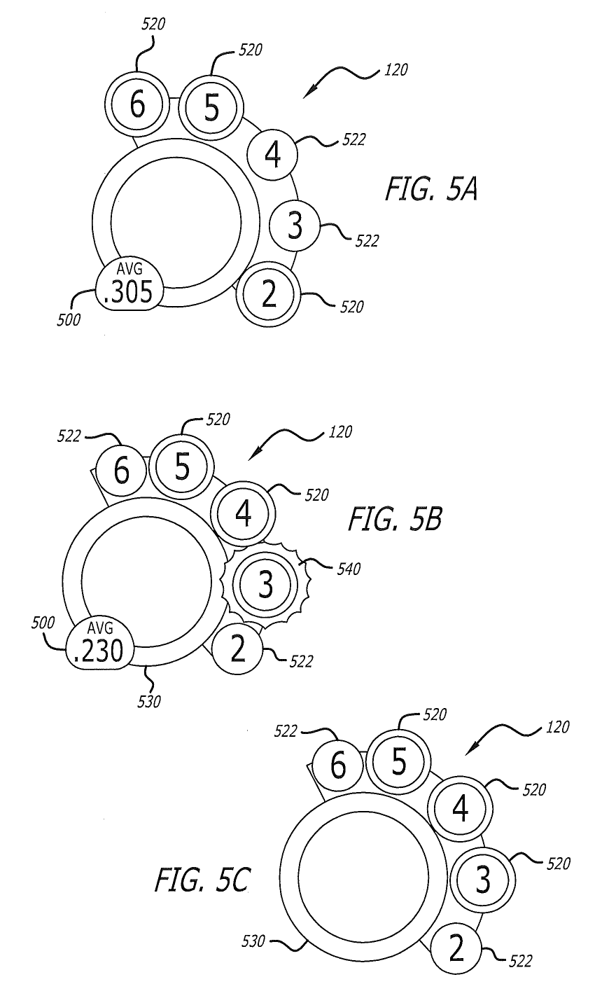

FIGS. 5A-5C illustrate various views of the strategy vista interface 120 in accordance with embodiment of the disclosure. In general, the strategy vista interface 120 comprises a statistical region 500 and a plurality of filter interfaces that are in an active or inactive state. In one embodiment, the reference to active or inactive state could be interpreted as selectable or un-selectable states, for a predetermined period of time, or instance in the game, for example. In one embodiment, the strategy vista 120 may feature three different active state filter interfaces 520, however it is envisioned that this number may be increased or decreased without limitation. As shown in FIG. 5A, the statistical region 500 is configured to indicate a batting average with respect to a particular player. However, any other statistic may be included in the statistical region 500 without limitation. In one embodiment, the statistical region 500 is capable of alternative between various statistics. Furthermore, it is envisioned that multiple statistics may be displayed at one time in the region 500.

In one embodiment, the strategy vista interface 120 is dynamic, and thus it may be generated when the user clicks and/or otherwise interacts with a specific player using the gaming system 100 as discussed herein. In one embodiment, the strategy vista 120 features filter interfaces in active state 520, and an inactive state 522. As shown in FIG. 5A, in an active state 520, certain offensive options, e.g., “2”, “5”, or “6” are available selection by the user if a player attribute is above and/or below a certain predetermined value. For example, in one embodiment, an active state 520 may be available if the batting average of the selected player is greater than or equal to a predetermined threshold value. It is envisioned that filter interfaces in an active state 520 may be differentiated from inactive states 522 using any combination of larger numbers, various colors, and/or various features such as animations without limitation. In one embodiment, filter interfaces in an inactive state 522 may be represented using smaller numbers and/or darker colors, etc. as compared to the filter interfaces in an active state 520, without limitation. It should be understood that the purpose of such differentiation is so that the user has an easy to use interface that allows strategic decisions to be made with relative ease while playing the game.

In one embodiment, the active state interfaces 520 may correspond to the offensive filters 415 as discussed with respect to FIG. 4A. Consequently, when a particular game is being played, the player (if on offense) has the opportunity to determine the play outcome. In the exemplary baseball scenario, the pitcher has control of the ball, and a pair of defensive outcomes are determined. Based on the pair of defensive outcomes, a certain type of pitch is activated. In response, the user may select an offensive outcome, such as via the active state filter interface 520. By way of non-limiting example, if an offensive option “5” appears and is selected, perhaps a home run may result, if the outcome matrix 400 provides as such. Alternatively, a different offensive outcome may result. As shown in FIG. 5A, certain offensive outcomes are in an inactive state 522, and thus, are not available for selection. It should be understood that this process may be iteratively repeated until the game or inning ends. The duration of the game may be programmed or configured by the user, or by a developer, for example.

As shown in FIG. 5B, the strategy vista 120 may feature a clutch ring 540 that may be activated if a user accumulates a predetermined amount of points while using the gaming system 100. In one embodiment, the clutch ring 540 is pre-programmed such that certain players in the game have a clutch option at various innings, etc., in the game. It is envisioned that only certain players will have the clutch ring 540, thereby making it a special option, for example. In one embodiment, the clutch ring 540 may be utilized so as to force a home run, cause a grand-slam, or catch a ball off the wall, without limitation.

Referring still to FIG. 5B, in one embodiment, fictional or non-fictional players may be programmed using the system 100. When the player takes their turn at bat, the strategy vista interface 120 alters its appearance in accordance with the selected player's batting average. For example, a fictional player “Dave Winn” may have a .230 average, which is displayed in the statistical region 500. To alter its appearance accordingly, the GUI 105 activates offensive options 3, 4 and 5; while deactivating options 2 and 6. Additionally, in one embodiment, if the team or player at-bat has a clutch ring 540 active, that option may be shaded in a prominent color, such as gold. It should be understood that this methodology may be implemented by focusing on any particular statistic as desired, without limitation. In one embodiment, as shown in FIG. 5C, once the clutch option has been applied, a separate color may be implemented so as to reflect an inactive clutch status, for example using a subdued color.

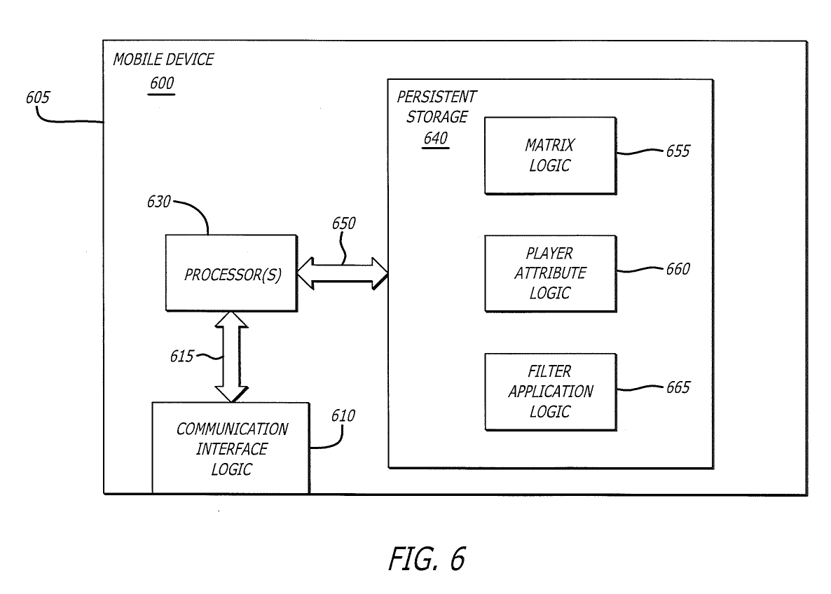

FIG. 6 illustrates an exemplary mobile device 600 in accordance with embodiments of the disclosure. For illustrative purposes, the network device is represented as a mobile device 600 (e.g., smartphone, tablet, laptop computer, netbook, etc.). In one embodiment, a mobile device 600 may feature a housing 605, which is made entirely or partially of a rigid material (e.g., hardened plastic, metal, glass, composite or any combination thereof) that protect circuitry within the housing 605, namely one or more processors 630 that are coupled to communication interface logic 610 via a first transmission medium 615. Communication interface logic 610 enables communications with an end user, for example, so as to generate images. Consequently, in one embodiment, the interface logic 610 may feature graphic generating capability.

Processor(s) 630 may further be coupled to persistent storage 640 via a second transmission medium 650. According to one embodiment of the disclosure, persistent storage 640 may include the matrix logic 655, player attribute logic 660, and filter application logic 665. It is envisioned that one or more of these systems (or logic units) could be implemented externally from the mobile device 600 without extending beyond the spirit and scope of the present disclosure. In one embodiment, the outcome matrix 400 may be stored within the matrix logic 655 of the persistent storage 640, using a database that may be updated on an as-needed basis. Similarly, the player attribute logic table 300 may be stored within the player attribute logic block 660 of the persistent storage 640. In one embodiment, the methodology of filtration, and various other game play characteristics may be implemented using the filter application logic 665. In one embodiment, data from the persistent storage 640 may be processed and thereby transformed using the processor(s) 630, for example. In one embodiment, such transformation may include, by way of non-limiting example, loading player attributes and statistics; loading a set of all potential outcomes, and applying a plurality of offensive and defensive filters so as to yield actual game play scenarios wherein a certain team, player and action are chosen.

In one embodiment, it is contemplated that all of the various matrices and logic tables may be stored on a single database within the persistent storage. However, it should be appreciated that buy separating the various logic modules, one benefit is increased flexibility, such that a number of various game types may be implemented using the system 100. More specifically, the same logic and hardware configuration may be utilized for basketball, soccer, or any other competitive sport that can be adapted into a game.

Although not illustrated, it is contemplated that all or a portion of the functionality of the gaming system 100 may be deployed at part of cloud services. For instance, the matrix logic may be deployed in cloud services, which features, in one embodiment, data stored in the outcome matrix 400. Therefore, it is within the spirit of the invention that the gaming system 100 may reside entirely within a single mobile device, or may be deployed as a decentralized system with different functionality being handled by different network devices, including cloud services.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. To the extent there are variations of the invention, which are within the spirit of the disclosure or equivalent to the inventions found in the claims, it is the intent that this patent will cover those variations as well. Therefore, the present disclosure is to be understood as not limited by the specific embodiments described herein, but only by scope of the appended claims.

1. A sports strategy system, comprising:
a processor;
storage media communicatively coupled to the processor, the storage media including logic configured to display a graphical user interface comprising a strategy vista interface and a background comprising one or more sport-specific elements and a score region;
the storage media further comprising:
player attribute logic that is configured to store a plurality of player profiles that correspond to a plurality of players in a sports game;
matrix logic that is configured to store all potential game outcomes; and
filter application logic that is configured to store offensive and defensive filters so as to provide one or more game scenarios.

2. The sports strategy system of claim 1, wherein the player attribute logic comprises any one of the first and last name of a player, a player nickname, a quality score, a field position, and the player's favorite hand.

3. The sports strategy system of claim 1, wherein the strategy vista interface is configured display when a player is selected.

4. The sports strategy system of claim 1, wherein the matrix logic features an outcome matrix comprising a defensive filter and an offensive filter.

5. The sports strategy system of claim 4, wherein the defensive filter comprises a plurality of rows that are representative of various defensive outcomes in the context of a sports game.

6. The sports strategy system of claim 5, wherein the defensive filter comprises a pair of numerical values.

7. The sports strategy system of claim 6, wherein the pair of numerical values is determined using randomization logic.

8. The sports strategy system of claim 4, wherein the offensive filter comprises a plurality of columns, each column corresponding to an offensive decision may be made by the game user.

9. The sports strategy system of claim 8, wherein the offensive filter comprises a single numerical value.

10. The sports strategy system of claim 1, wherein the strategy vista interface comprises a statistical region and a plurality of filter interfaces.

11. The sports strategy system of claim 10, wherein the filter interfaces may be displayed in an active or inactive state, depending on the player that is selected.

12. The sports strategy system of claim 1, wherein the sports game is baseball.

13. A computerized method for a sports strategy game, comprising:
a processor;
storage media communicatively coupled to the processor, the storage media including logic configured to:
display a graphical user interface comprising a strategy vista interface and a background comprising one or more sport-specific elements and a score region;
storing a plurality of player profiles that correspond to a plurality of players using player attribute logic;
storing potential game outcomes using matrix logic;
establishing a defensive scenario and providing the user the ability to select an offensive scenario; and
filtering all potential game outcomes so as to display a game scenario.

14. The sports strategy system of claim 13, wherein the player attribute logic comprises any one of the first and last name of a player, a player nickname, a quality score, a field position, and the player's favorite hand.

15. The sports strategy system of claim 13, wherein the strategy vista interface is configured display when a player is selected.

16. The sports strategy system of claim 13, wherein the matrix logic features an outcome matrix comprising a defensive filter and an offensive filter.

17. The sports strategy system of claim 16, wherein the defensive filter comprises a plurality of rows that are representative of various defensive outcomes in the context of a sports game.

18. The sports strategy system of claim 16, wherein the defensive filter comprises a pair of numerical values.

19. The sports strategy system of claim 18, wherein the pair of numerical values is determined using randomization logic.

20. The sports strategy system of claim 16, wherein the offensive filter comprises a single numerical value.
